(19) United States
(12) Patent Application Publication
(10) Pub. No.: US 2015/0310480 A1
(43) Pub. Date: Oct. 29, 2015

(54) METHOD, SERVER AND SYSTEM FOR MONITORING AND IDENTIFYING TARGET TERMINAL DEVICES

(71) Applicant: Xiaomi Inc., Beijing (CN)

(72) Inventors: Fang Liu, Beijing (CN); Zhenhua Liu, Beijing (CN)

(21) Appl. No.: 14/622,920

(22) Filed: Feb. 16, 2015

Related U.S. Application Data
(63) Continuation of application No. PCT/CN2014/091185, filed on Nov. 14, 2014.

(30) Foreign Application Priority Data
Apr. 25, 2014 (CN) 201410171902.1

(51) Int. Cl. G06Q 30/02

(52) U.S. Cl. CPC G06Q 30/0242; G06Q 30/0272

(57) ABSTRACT

The present disclosure relates to a method, server and system for identifying target terminal devices. The method for identifying target terminal devices comprises: obtaining visiting records of terminal devices visiting a designated location; obtaining a plurality of first browsing records of promotional information corresponding to each terminal device that visits the designated location; and identifying the target terminal devices according to the visiting records and the plurality of first browsing records, wherein the target terminal devices are terminal devices visiting the designated location after browsing promotional information corresponding to the designated location.

### CROSS REFERENCE TO RELATED APPLICATION

This application is a Continuation application of International Application No. PCT/CN2014/091185, with an international filing date of Nov. 14, 2014, which is based upon and claims priority to Chinese Patent Application No. 201410171902.1, filed with the State Intellectual Property Office of P. R. China on Apr. 25, 2014, the entire contents of which are incorporated herein by reference.

### TECHNICAL FIELD

The present disclosure generally relates to the field of Internet technology, and more particularly, to a method, server and system for monitoring and identifying target terminal devices.

### BACKGROUND

With the development of the Internet, more and more vendors put out promotional information of their commodities on the Internet. That is, if a vendor wants to publish promotional information, he/she may put the promotional information on a website.

In an actual implementation, if a vendor wants to put promotional information on a website, the vendor may upload the promotional information to a web server. When a user visits the website, the web server sends the promotional information to the user. Thus, the user may purchase in the shop of the vendor after browsing the promotional information. For example, a shop offers a 50% discount on all commodities during an anniversary celebration and publishes promotional information of selling clothes at a 50% discount on a website, such that a user may go to the shop to purchase after the user visits the website and sees the promotional information.

### SUMMARY

The embodiments of the present disclosure provide a method, device and system for monitoring and identifying target terminal devices.

According to a first aspect of embodiments of the present disclosure, there is provided a method for identifying target terminal devices, comprising: obtaining visiting records of terminal devices visiting a designated location; obtaining a plurality of first browsing records of promotional information corresponding to each terminal device that visits the designated location; and identifying the target terminal devices according to the visiting records and the plurality of first browsing records, wherein the target terminal devices are terminal devices visiting the designated location after browsing promotional information corresponding to the designated location

According to a second aspect of embodiments of the present disclosure, there is provided a method for monitoring terminal devices, comprising: obtaining terminal device identifications of the terminal devices visiting a designated location; recording a visiting time of the terminal devices; generating visiting records of the terminal devices visiting the designated location according to the terminal device identifications and the visiting time of the terminal devices; sending the visiting records to a server, wherein the visiting records are configured for instructing the server to obtain a plurality of first browsing records of promotional information corresponding to each terminal device that visits the designated location; and identifying target terminal devices according to the visiting records and the plurality of first browsing records, wherein the target terminal devices are terminal devices visiting the designated location after browsing promotional information corresponding to the designated location.

According to a third aspect of embodiments of the present disclosure, there is provided a server for identifying target terminal devices, comprising: a memory; and one or more processors; wherein the one or more processors are stored in the memory and are configured to perform: obtaining visiting records of terminal devices visiting a designated location; obtaining a plurality of first browsing records of promotional information corresponding to each terminal device that visits the designated location; and identifying the target terminal devices according to the visiting records and the plurality of first browsing records, wherein the target terminal devices are terminal devices visiting the designated location after browsing promotional information corresponding to the designated location.

It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic diagram illustrating an operating environment of a method for identifying target terminal devices according to some exemplary embodiments of the present disclosure.

FIG. 2 is a flow chart of a method for identifying target terminal devices according to an exemplary embodiment of the present disclosure.

FIG. 3 is a flow chart of a method for monitoring terminal devices according to an exemplary embodiment of the present disclosure.

FIG. 4A is a schematic diagram illustrating a process of a method for identifying target terminal devices according to an exemplary embodiment of the present disclosure.

FIG. 4B is a schematic diagram illustrating a process of another method for identifying target terminal devices according to an exemplary embodiment of the present disclosure.

FIG. 4C is a schematic diagram illustrating an operating environment of a method for identifying target terminal devices according to an exemplary embodiment of the present disclosure.

FIG. 5 is a block diagram of an apparatus for identifying target terminal devices according to an exemplary embodiment of the present disclosure.

FIG. 6A is a block diagram of an apparatus for identifying target terminal devices according to an exemplary embodiment of the present disclosure.

FIG. 6B is a block diagram of a terminal device detecting unit according to an exemplary embodiment of the present disclosure.

FIG. 6C is a block diagram of another apparatus for identifying target terminal devices according to an exemplary embodiment of the present disclosure.

FIG. 7 is a block diagram of an apparatus for monitoring terminal devices according to an exemplary embodiment of the present disclosure.

FIG. 8 is a block diagram of another apparatus for monitoring terminal devices according to an exemplary embodiment of the present disclosure.

FIG. 9 is a schematic diagram of a server according to an exemplary embodiment of the present disclosure.

FIG. 10 is a schematic diagram of a monitor according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

FIG. 1 is a schematic diagram illustrating an operating environment of a method for identifying target terminal devices according to some exemplary embodiments of the present disclosure. As shown in FIG. 1, in the operating environment, there are a monitor 110 and a server 120.

The monitor 110 is an electronic device provided at a designated location and is configured for collecting visiting records of terminal devices visiting the designated location. The monitor 110 may be connected with the server 120 via a wired or wireless network, such that the monitor 110 may send the visiting records to the server 120.

The server 120 may be connected with the monitor 110 via a wired or wireless network. The server 120 may obtain a plurality of first browsing records of promotional information corresponding to the terminal devices, and obtain the visiting records of the terminal devices visiting the designated location from the monitor 110, such that the server 120 may determine whether the terminal devices visiting the designated location are terminal devices visiting the designated location after browsing promotional information corresponding to the designated location according to the visiting records and the plurality of first browsing records.

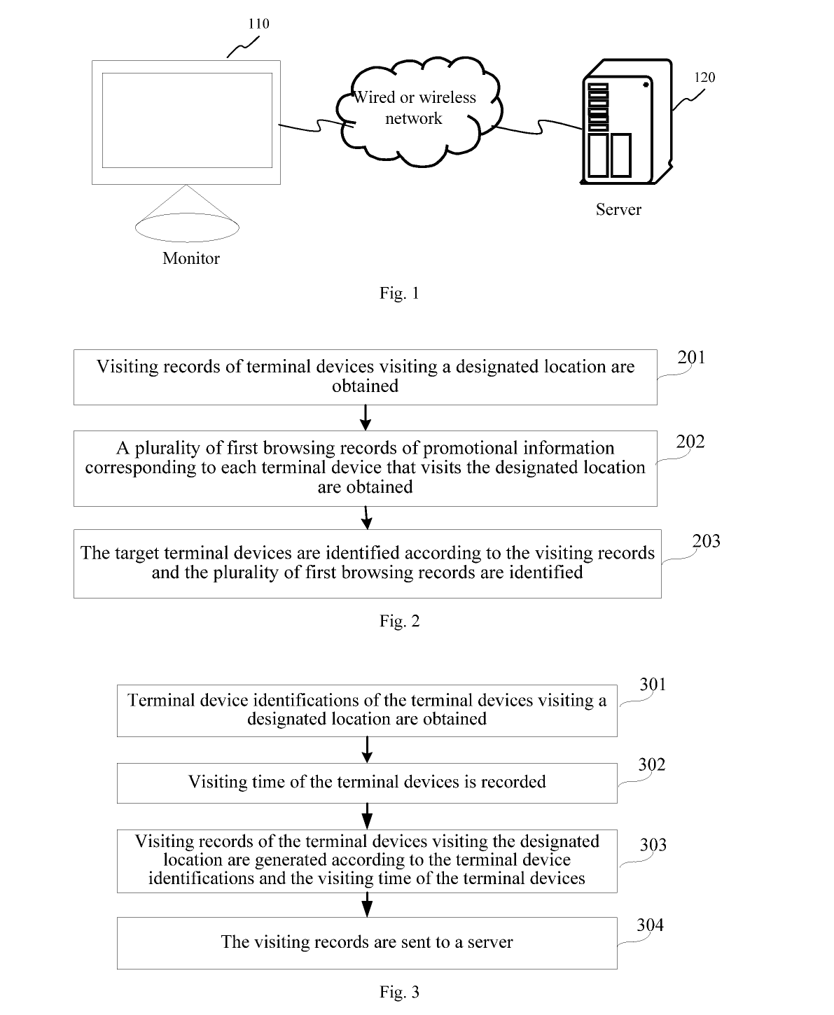

FIG. 2 is a flow chart of a method for identifying target terminal devices according to an exemplary embodiment of the present disclosure. As shown in FIG. 2, the method for identifying the target terminal devices is applied in the server 120 in the operating environment illustrated in FIG. 1. The method for identifying the target terminal devices may include the following steps.

In step 201, visiting records of terminal devices visiting a designated location are obtained.

In step 202, a plurality of first browsing records of promotional information corresponding to each terminal device that visits the designated location are obtained.

In step 203, the target terminal devices are identified according to the visiting records and the plurality of first browsing records, in which the target terminal devices are terminal devices visiting the designated location after browsing promotional information corresponding to the designated location.

As described above, according to the method for identifying the target terminal devices in the embodiments of the present disclosure, by obtaining the visiting records of the terminal devices visiting the designated location, by obtaining the plurality of first browsing records of the promotional information corresponding to each terminal device that visits the designated location, and by identifying the target terminal devices according to the visiting records and the plurality of first browsing records in which the target terminal devices are terminal devices visiting the designated location after browsing promotional information corresponding to the designated location, the problem in a related art that a vendor cannot determine whether the promotional information published on a website appeals to customers (namely users of terminal devices) or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers did the promotional information published on the website help to bring in.

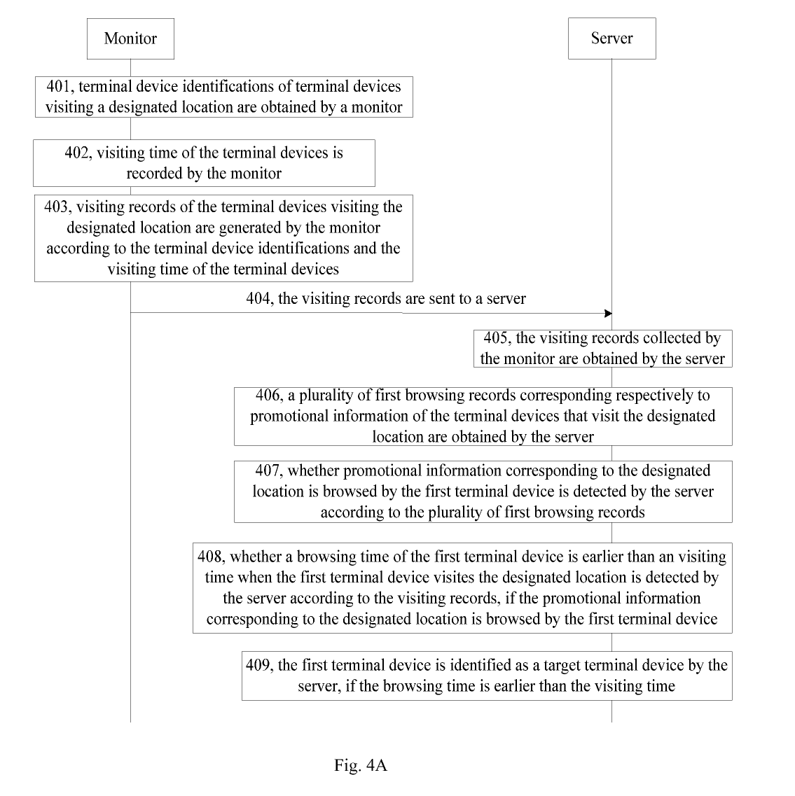

FIG. 3 is a flow chart of a method for monitoring terminal devices according to an exemplary embodiment of the present disclosure. As shown in FIG. 3, the method for monitoring terminal devices is applied in the monitor 110 in the operating environment illustrated in FIG. 1. The method for monitoring terminal devices may include the following steps.

In step 301, terminal device identifications of terminal devices visiting a designated location are obtained.

In step 302, a visiting time of the terminal devices is recorded.

In step 303, visiting records of the terminal devices visiting the designated location are generated according to the terminal device identifications and the visiting time of the terminal devices.

In step 304, the visiting records are sent to a server.

The visiting records are configured for instructing the server to obtain a plurality of first browsing records of promotional information corresponding to each terminal device that visits the designated location, and to identify target terminal devices according to the visiting records and the plurality of first browsing records, in which the target terminal devices are terminal devices visiting the designated location after browsing promotional information corresponding to the designated location.

As described above, according to the method for monitoring the terminal devices in the embodiments of the present disclosure, by obtaining the terminal device identifications of the terminal devices visiting the designated location, by recording the visiting time of the terminal devices, by generating the visiting records of the terminal devices visiting the designated location according to the terminal devices identifications and the visiting time of the terminal devices, and sending the visiting records to the server such that the server may obtain the plurality of first browsing records corresponding respectively to promotional information of the terminal devices that visit the designated location and then identifying the target terminal devices according to the visiting records and the plurality of first browsing records, in which the target terminal devices are terminal devices visiting the designated location after browsing promotional information corresponding to the designated location, the problem in a related art that a vendor cannot determine whether the promotional information published on a website appeals to customers or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers the promotional information published on the website help to bring in.

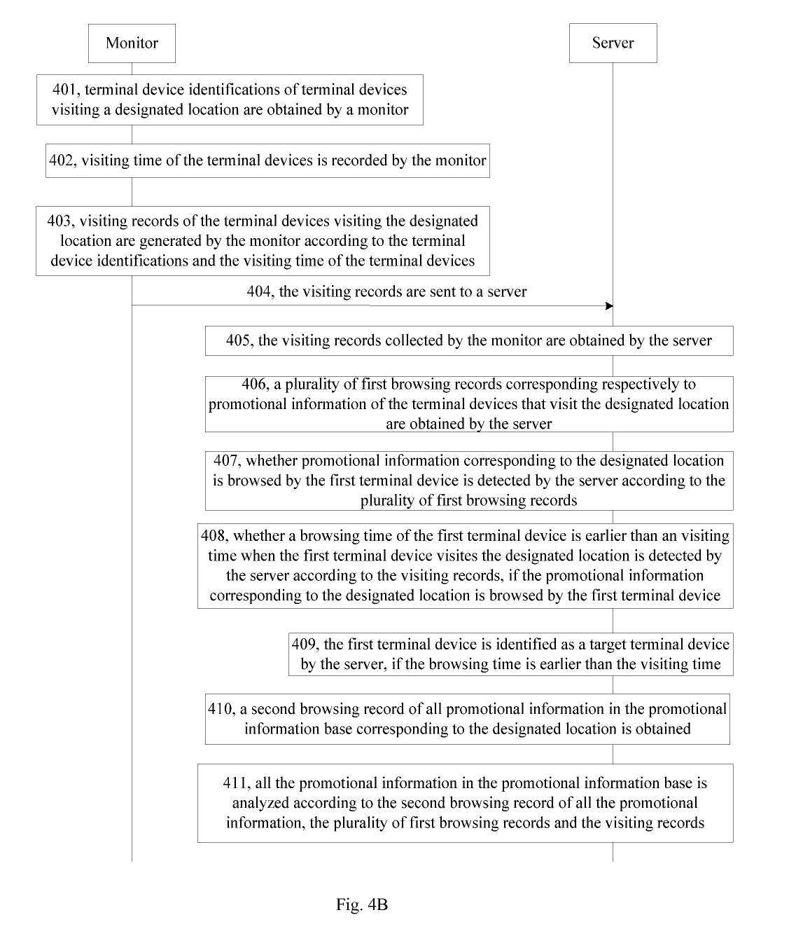

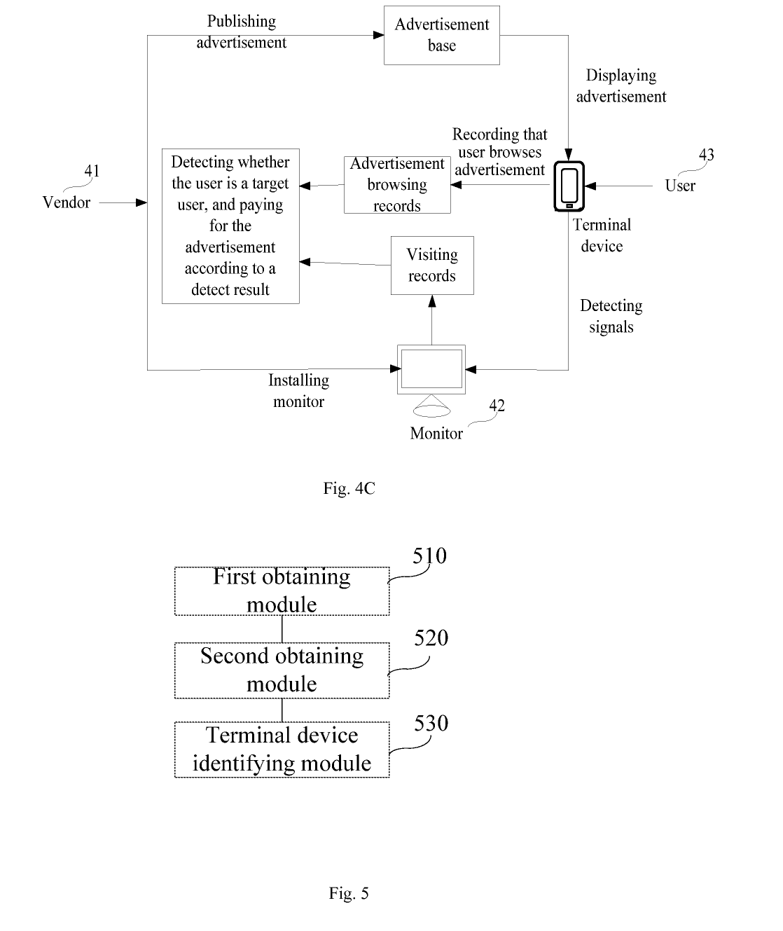

FIG. 4A is a schematic diagram illustrating a process of a method for identifying target terminal devices according to an exemplary embodiment of the present disclosure. As shown in FIG. 4, the method for identifying the target terminal devices is applied in the operating environment illustrated in FIG. 1. The method for identifying the target terminal devices may include the following steps.

In step 401, terminal device identifications of terminal devices visiting a designated location are obtained by a monitor.

A vendor may install a monitor in his/her shop, such that when users carrying terminal devices enter the shop, the monitor may obtain terminal device identifications of the terminal devices visiting the shop. For example, when a user “Xiaohua” enters a shop “XX clothes shop”, a monitor in the “XX clothes shop” may obtain a terminal device identification of a terminal device carried by “Xiaohua”.

In an actual implementation, the step of obtaining the terminal device identifications of the terminal devices visiting the designated location by the monitor may include the following steps.

Firstly, a broadcasting signal sent by a first terminal device is received, in which the broadcasting signal comprises a wireless local area network (WLAN, such as WiFi) signal and/or Bluetooth signal.

The first terminal device can send the broadcasting signal in real time. For example, if the first terminal device activates a WiFi function, the first terminal device may broadcast the WiFi signal in real time; if the first terminal device activates a Bluetooth function, the first terminal device may broadcast the Bluetooth signal in real time. Thus, when the first terminal device enters an area monitored by the monitor, the monitor may receive the broadcasting signal sent by the first terminal device. In an actual implementation, the broadcasting signal sent by the first terminal device may comprise a MAC (Media Visit Control) address of the first terminal device.

Secondly, a terminal device identification of the first terminal device is extracted from the broadcasting signal, in which the terminal device identification comprises a MAC address of the first terminal device.

After receiving the broadcasting signal, the monitor may extract the terminal device identification of the first terminal device from the broadcasting signal, in which the terminal device identification comprises the MAC address of the first terminal device.

In step 402, visiting time of the terminal devices is recorded by the monitor.

The monitor may record visiting time of the terminal devices. In an actual implementation, since the broadcasting signal sent by the first terminal device is received by the monitor, the first terminal device is at the designated location, and thus the monitor may record the time when the broadcasting signal sent by the first terminal device is received and define the recorded time as visiting time of the first terminal device.

In step 403, visiting records of the terminal devices visiting the designated location are generated by the monitor according to the terminal device identifications and the visiting time of the terminal devices.

In an actual implementation, in order to distinguish visiting records generated by different monitors, i.e. to distinguish visiting records of different designated locations, the visiting records generated by the monitor may also include a designated location identification of the designated location, which is not limited in the embodiments of the present disclosure.

In step 404, the visiting records are sent to a server.

After generating the visiting records, the monitor may send the visiting records to the server.

The visiting records are configured for instructing the server to obtain the plurality of first browsing records of promotional information of the terminal devices that visit the designated location, and to identify the target terminal devices according to the visiting records and the plurality of first browsing records, in which the target terminal devices are terminal devices visiting the designated location after browsing promotional information corresponding to the designated location.

In step 405, the visiting records collected by the monitor are obtained by the server.

Correspondingly, the server may obtain visiting records collected by the monitor.

It should be explained that, this embodiment merely takes an example of the monitor initiating the sending of the visiting records to the server after generating the visiting records. In an actual implementation, the monitor may send the visiting records to the server after receiving a requesting signal for requesting the visiting records sent by the server instead of initiating the sending of the visiting records to the server, which is not limited in the embodiments of the present disclosure. Also, in an actual implementation, the server may request the visiting records from the monitor at predetermined intervals, which is not limited in the embodiments of the present disclosure.

In step 406, the plurality of first browsing records of promotional information corresponding to the terminal devices that visit the designated location are obtained by the server.

After obtaining the visiting records of the terminal devices visiting the designated location, the server may obtain the plurality of first browsing records of the promotional information of the terminal devices that visit the designated location. Since terminal devices recorded in the visiting records are the terminal devices visiting the designated location, the server may obtain the plurality of first browsing records corresponding respectively to the promotional information of the terminal devices recorded in the visiting records.

In an actual implementation, a web server may record a first browsing record of the first terminal device when a user visits the website and browses promotional information using the first terminal device, in which the web server is a server corresponding to a webpage browsed by the user. For example, when the user browses a webpage “X forum”, the web server is a server of the webpage “X forum”. Of course, in an actual implementation, when the user browses the promotional information, the first terminal device of the user may send a browsing request to other server such that the other servers may record the first browsing record of the first terminal device, which is not limited in the embodiments of the present disclosure. Moreover, the web server and the other server may be the server in this embodiment, which are not limited in the embodiments of the present disclosure. Also, if the web server or the other server recording the plurality of first browsing records is not the server in this embodiment, the server may obtain the plurality of first browsing records of promotional information of the terminal devices, and if the web server or the other server is the server in this embodiment, the server may obtain the plurality of first browsing records of promotional information of the terminal devices directly. The method for obtaining the plurality of first browsing records is not limited in the embodiments of the present disclosure.

It should be explained that, in order to identify which promotional information is browsed by the first terminal device and when the promotional information is browsed, the first browsing record may include a promotional information identification and a browsing time of the first terminal device, and in order to distinguish different terminal devices, the first browsing record may also include a terminal device identification of the first terminal device. Of course, in an actual implementation, the first browsing record may include other information according to different requirements. For example, in order to identify which shop the promotional information is used for advertising, the first browsing record may further include a designated location identification corresponding to the promotional information. The content of the first browsing record is not limited in the embodiments of the present disclosure.

In step 407, whether promotional information corresponding to the designated location is browsed by the first terminal device is detected by the server according to the plurality of first browsing records.

After receiving the plurality of first browsing records, the server may detect whether the promotional information corresponding to the designated location is browsed by the first terminal device according to the plurality of first browsing records.

The detecting method for detecting whether the promotional information corresponding to the designated location is browsed by the first terminal device may include any of the following manners.

First Manner

Whether there is the first browsing record comprising the terminal device identification of the first terminal device and the designated location identification of the designated location is detected, if every first browsing records comprises the terminal device identification, the promotional information identification, the designated location identification and the browsing time corresponding to the promotional information.

If each first browsing record comprises the terminal device identification, the promotional information identification, the designated location identification and the browsing time corresponding to the promotional information, the server may detect whether there is a first browsing record comprising the terminal device identification of the first terminal device and the designated location identification of the designated location. If there is the first browsing record comprising the terminal device identification of the first terminal device and the designated location identification of the designated location in the plurality of first browsing records, it is detected that the promotional information corresponding to the designated location is browsed by the first terminal device. If there is not the first browsing record comprising the terminal device identification of the first terminal device and the designated location identification of the designated location in the plurality of first browsing records, it is detected that the promotional information corresponding to the designated location is not browsed by the first terminal device.

In an actual implementation, the server may select a first browsing record comprising the terminal device identification of the first terminal device, and then detect whether the first browsing record comprises the designated location identification of the designated location, if the first browsing record comprises the designated location identification, it is detected that the promotional information corresponding to the designated location is browsed by the first terminal device, otherwise it is detected that the promotional information corresponding to the designated location is not browsed by the first terminal device.

Second Manner

A promotional information library corresponding to the designated location is obtained and whether the promotional information corresponding to the designated location is browsed by the first terminal device is detected according to the first browsing record and the promotional information library, if each first browsing records comprises the terminal device identification, the promotional information identification and the browsing time.

If each first browsing record merely comprises the terminal device identification, the promotional information identification and the browsing time, the server may obtain the promotional information library corresponding to the designated location to determine whether the promotional information recorded in the first browsing record is the promotional information corresponding to the designated location, such that the server may detect whether the promotional information corresponding to the designated location is browsed by the first terminal device according to the first browsing record and the promotional information library.

Since the server may establish a correlation between the promotional information identification and the designated location identification of the designated location promoted by a vendor when the vendor publishes promotional information, the server may inquire the correlation to obtain the promotional information library corresponding to the designated location.

Moreover, the step of detecting whether the promotional information corresponding to the designated location is browsed by the first terminal device according to the first browsing record and the promotional information library may include the following step.

The server detects whether the promotional information recorded in the first browsing record is in the obtained promotional information library, if the detection result indicating that the promotional information recorded in the first browsing record is in the obtained promotional information library, the server may determine that the promotional information corresponding to the designated location is browsed by the first terminal device.

In step 408, whether the browsing time of the first terminal device is earlier than a visiting time when the first terminal device visits the designated location is detected by the server according to the visiting records, if the promotional information corresponding to the designated location is browsed by the first terminal device.

In order to further detect whether the promotional information corresponding to the designated location is browsed by the first terminal device before the first terminal device visits the designated location, the server may detect whether the browsing time of the first terminal device is earlier than the visiting time when the first terminal device visits the designated location according to the visiting records.

Since a vendor may publish identical promotional information on the internet for a long time, and after browsing the promotional information, the user usually visits the corresponding designated location to purchase in a short period of time instead of waiting a long period of time before visiting the corresponding designated location to purchase after browsing the promotional information, the step of detecting whether the browsing time of the first terminal device is earlier than the visiting time when the first terminal device visits the designated location according to the visiting records may include the step of detecting whether the browsing time of the first terminal device is within a predetermined time range according to the visiting records.

If a detection result of the server indicates that the browsing time of the first terminal device is within the predetermined time range, the server may determine that the browsing time of the first terminal device is earlier than the visiting time when the first terminal device visits the designated location; if the detection result of the server indicates that the browsing time of the first terminal device is not within the predetermined time range, since the user may forget the promotional information browsed by him/her, the server may not determine that the promotional information corresponding to the designated location is browsed by the first terminal device before the first terminal device visits the designated location. At this time, the procedure may be finished.

The predetermined time range is a period of time earlier than the visiting time when the first terminal device visits the designated location. For example, the predetermined time range is from a month earlier than the visiting time when the first terminal device visits the designated location to the visiting time.

In step 409, the first terminal device is identified as the target terminal device by the server, if the browsing time is earlier than the visiting time.

If a detection result of the server indicates that the browsing time of the first terminal device is earlier than the visiting time, the server may determine that the first terminal device is the terminal device visiting the designated location after browsing promotional information of the designated location, i.e. the server identifies the first terminal device as the target terminal device. The target terminal device is a terminal device visiting the designated location after browsing the promotional information corresponding to the designated location.

It should be explained that, since the target terminal device is carried by a customer that the promotional information appeals to and that yields a profit to the vendor, the vendor may pay for the promotional information published on the website according to a number of the target terminal devices visiting the designated location, such that the problem that the vendor pays for the promotional information while the published promotional information appeals to none or few customers. Meanwhile, the vendor may obtain the number of the target terminal devices visiting his/her shop from the server, and record a spending amount of a customer when the customer purchases a commodity, such that the vendor may calculate the profit yielded by each target terminal device, that is, the vendor may determine whether the published promotional information yields a profit.

As described above, according to the method for identifying the target terminal devices in the embodiments of the present disclosure, by obtaining the visiting records of the terminal devices visiting the designated location, by obtaining the plurality of first browsing records of the promotional information corresponding to each terminal device that visits the designated location, and by identifying the target terminal devices according to the visiting records and the plurality of first browsing records in which the target terminal devices are terminal devices visiting the designated location after browsing promotional information corresponding to the designated location, the problem in a related art that a vendor cannot determine whether the promotional information published on a website appeals to customers or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers did the promotional information published on the website help to bring in.

In this embodiment, when the terminal device enters in the area monitored by the monitor, the monitor may obtain the terminal device identification of the terminal device according to the broadcasting signal sent by the terminal device conveniently and efficiently, and the user need not perform any operation, and an effect that the monitor calculates customer flows of the shop conveniently is achieved.

It should be explained that, referring to FIG. 4B, after identifying the target terminal devices, the server may further execute the following steps.

In step 410, a second browsing record of all promotional information in the promotional information library corresponding to the designated location is obtained.

The server may obtain the second browsing record of all promotional information in the promotional information library corresponding to the designated location. In an actual implementation, firstly the server may obtain the promotional information library corresponding to the designated location, and then may obtain the second browsing record of all promotional information in the promotional information library, which are not elaborated herein.

In step 411, all promotional information in the promotional information library is analyzed according to the second browsing record, the plurality of first browsing records and the visiting records.

The step of analyzing all promotional information in the promotional information library by the server according to the second browsing record, the plurality of first browsing records and the visiting records may include the following steps.

Firstly, a number of the target terminal devices corresponding to first promotional information are calculated according to the visiting records and the plurality of first browsing records.

The server may calculate the number of the target terminal devices corresponding to first promotional information according to the visiting records and the plurality of first browsing records. In an actual implementation, the server may classify the identified target terminal devices according to the promotional information browsed by the target terminal devices, and then count the number of the target terminal devices corresponding to each promotional information, i.e. the number of each class of target terminal devices.

Secondly, times that the first promotional information is browsed are calculated according to the second browsing record of all promotional information.

In an actual implementation, the server may count a number of browsing records corresponding to the first promotional information in the second browsing record of all promotional information, and then the counted number may be used as the times that the first promotional information is browsed.

Thirdly, a conversion rate of the first promotional information is calculated according to the number and the times.

The server may calculate the conversion rate of the first promotional information according to the number and the times. In an actual implementation, the server may calculate a ratio of the number of the target terminal devices corresponding to the first promotional information to the times that the first promotional information is browsed, and then the calculated ratio may be used as the conversion rate of the first promotional information, such that the server may quantify an effect of the first promotional information. In an actual implementation, in order to improve the conversion rate of the first promotional information, with respect to a first target terminal device, the server may determine a type of a promoted item corresponding to promotional information browsed by the first target terminal device according to the first browsing record of the first target terminal device, and select the promotional information corresponding to the type of the promoted item in the promotional information library of each shop, and then send promotional information in the selected promotional information other than the promotional information browsed by the first target terminal device to the first target terminal device. In this way, since all promotional information sent to the first target terminal device by the server is the promotional information of the item that the user may be interested in, the possibility that the user visits the designated location corresponding to promotional information after browsing the promotional information is high, such that the interference brought to the user caused by the fact that the promotional information sent to the first terminal device may useless to the user can be prevented, thus improving the users experience.

It should be explained that, one or more monitors in this embodiment might be provided. For example, if the area of the designated location is small, a monitor may obtain all terminal device identifications of terminal devices that visit the designated location, such that only one monitor may be installed in the shop. If the area of the designated location (such as a megamall) is big, since an irradiated area of the broadcasting signal sent by a terminal device is small, a monitor cannot meet a requirement for obtaining all terminal device identifications, at this time there may be two or more monitors, which is not limited in the embodiments of the present disclosure.

It should be explained that, referring to FIG. 4C, in an actual application, take the promotional information being an advertisement as an example, the vendor 41 may install in his/her shop the monitor 42 for monitoring terminal devices visiting the shop to identify which users of the users visiting the shop are target users, in which the target users are users visiting the shop after browsing the advertisement published on the internet by the vendor, such that the monitor 42 may monitor broadcasting signals sent by the terminal devices visiting the shop, and thus visiting records of the terminal devices visiting the shop may be obtained. In addition, when the vendor 41 publishes the advertisement on a platform, the platform may send the advertisement published by the vendor 41 to the user 43, and record an advertisement browsing record of the user 43 when the user 43 is browsing the advertisement. The system may obtain the visiting records corresponding to the shop from the monitor 42 at predetermined intervals and obtain the advertisement browsing records of the users from the platform, and then identify whether the users are target users according to the visiting records and the advertisement browsing records. In this way, the vendor may identify that which users in the users visiting the shop are target users through the system, and then the vendor may pay for the advertisement to the platform on which the advertisement is published according to the number of the target users, such that the problem that the vendor 41 pays a lot for the advertisement while the advertisement published by the vendor appeals to none or few customers.

Device embodiments of the present disclosure will be described below, which are configured to perform the method embodiments of the present disclosure. Concerning details not disclosed in the apparatus embodiments of the present disclosure, reference is made to the method embodiments of the present disclosure.

FIG. 5 is a block diagram of an apparatus for identifying target terminal devices according to an exemplary embodiment of the present disclosure. As shown in FIG. 5, the apparatus for identifying the target terminal devices is applied in the server 120 in the operating environment illustrated in FIG. 1, the apparatus for identifying the target terminal devices includes, but is not limited to, a first obtaining module 510, a second obtaining module 520 and a terminal device identifying module 530.

The first obtaining module 510 is configured for obtaining visiting records of terminal devices visiting a designated location.

The second obtaining module 520 is configured for obtaining a plurality of first browsing records of promotional information corresponding to each terminal device that visits the designated location.

The terminal device identifying module 530 is configured for identifying the target terminal devices according to the visiting records obtained by the first obtaining module 510 and the plurality of first browsing records obtained by the second obtaining module 520, in which the target terminal devices are terminal devices visiting the designated location after browsing promotional information corresponding to the designated location.

As described above, according to the apparatus for identifying target terminal devices in embodiments of the present disclosure, by obtaining the visiting records of the terminal devices visiting the designated location, by obtaining the plurality of first browsing records of the promotional information corresponding to each terminal device that visits the designated location, and by identifying the target terminal devices according to the visiting records and the plurality of first browsing records in which the target terminal devices are terminal devices visiting the designated location after browsing promotional information corresponding to the designated location, the problem in a related art that a vendor cannot determine whether the promotional information published on a website appeals to customers or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers did the promotional information published on the website help to bring in.

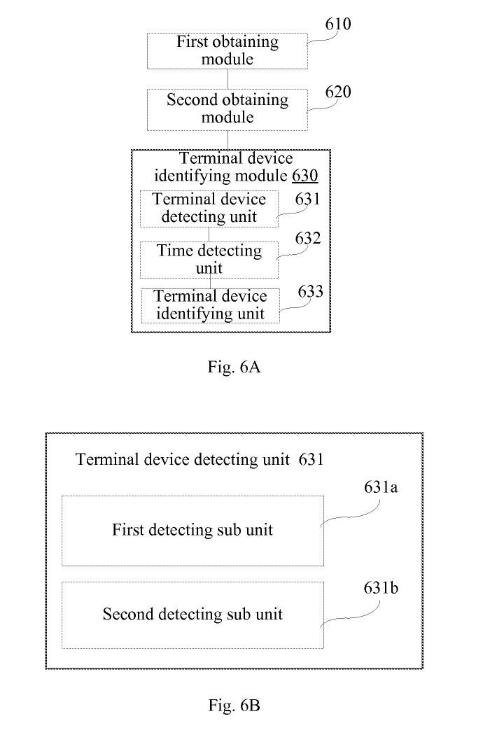

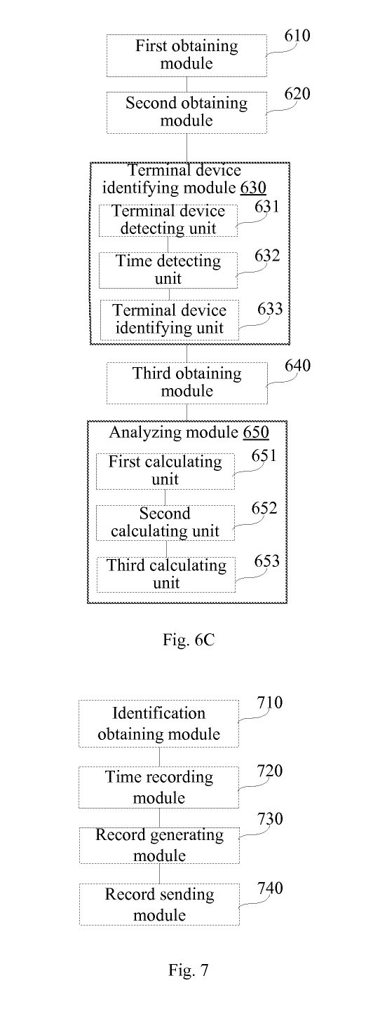

FIG. 6 is a block diagram of an apparatus for identifying target terminal devices according to an exemplary embodiment of the present disclosure. As shown in FIG. 6, the apparatus for identifying the target terminal devices is applied in the server 120 in the operating environment illustrated in FIG. 1, the apparatus for identifying the target terminal devices includes, but is not limited to, a first obtaining module 610, a second obtaining module 620 and a terminal device identifying module 630.

The first obtaining module 610 is configured for obtaining visiting records of terminal devices visiting a designated location.

The second obtaining module 620 is configured for obtaining a plurality of first browsing records corresponding respectively to promotional information of the terminal devices that visit the designated location.

The terminal device identifying module 630 is configured for identifying the target terminal devices according to the visiting records obtained by the first obtaining module 610 and the plurality of first browsing records obtained by the second obtaining module 620, in which the target terminal devices are terminal devices visiting the designated location after browsing promotional information corresponding to the designated location.

In a first possible implementation of this embodiment, the terminal device identifying module 630 includes: a terminal device detecting unit 631, configured for detecting whether the promotional information corresponding to the designated location is browsed by a first terminal device according to the plurality of first browsing records; a time detecting unit 632, configured for detecting whether a browsing time of the first terminal device is earlier than a visiting time when the first terminal device visits the designated location, if a detection result of the terminal device detecting unit 631 indicates that the promotional information corresponding to the designated location is browsed by the first terminal device; a terminal device identifying unit 633, configured for identifying the first terminal device as one of the target terminal devices, if a detection result of the time detecting unit 632 indicates that the browsing time is earlier than the visiting time.

Referring to FIG. 6B, in a second possible implementation of this embodiment, the terminal device detecting unit 631 includes: a first detecting sub unit 631a, configured for detecting whether there is a first browsing record comprising a terminal device identification of the first terminal device and a designated location identification of the designated location, if each first browsing record comprises a terminal device identification, a promotional information identification, a designated location identification and a browsing time corresponding to the promotional information; a second detecting sub unit 631b, configured for obtaining a promotional information library corresponding to the designated location and detecting whether the promotional information corresponding to the designated location is browsed by the first terminal device according to the first browsing record and the promotional information library, if each first browsing record comprises the terminal device identification, the promotional information identification and the browsing time.

In a third possible implementation of this embodiment, the time detecting unit 632 is configured for detecting whether the browsing time of the first terminal device is within a predetermined time range according to the visiting records, in which the predetermined time range is a period of time earlier than the visiting time when the first terminal device visits the designated location.

In a fourth possible implementation of this embodiment, the first obtaining module 610 is configured for obtaining the visiting records collected by a monitor, in which the visiting records are collected by the monitor provided at the designated location according to broadcasting signals sent by the terminal devices, in which the broadcasting signal comprises wireless local area network (WLAN, such as WiFi) signal and/or Bluetooth signal.

Referring to FIG. 6C, in a fifth possible implementation of this embodiment, the apparatus further includes: a third obtaining module 640, configured for obtaining a second browsing record of all promotional information in a promotional information library corresponding to the designated location; an analyzing module 650, configured for analyzing all promotional information in the promotional information library according to the second browsing record of all promotional information, the plurality of first browsing records and the visiting records.

In a sixth possible implementation of this embodiment, the analyzing module 650 includes: a first calculating unit 651, configured for calculating a number of the target terminal devices corresponding to first promotional information according to the visiting records and the plurality of first browsing records; a second calculating unit 652, configured for calculating times that the first promotional information is browsed according to the second browsing record of all promotional information; a third calculating unit 653, configured for calculating a conversion rate of the first promotional information according to the number calculated by the first calculating unit 651 and the times calculated by the second calculating unit 652.

As described above, according to the apparatus for identifying target terminal devices in the embodiments of the present disclosure, by obtaining the visiting records of the terminal devices visiting the designated location, by obtaining the plurality of first browsing records of the promotional information corresponding to each terminal device that visits the designated location, and by identifying the target terminal devices according to the visiting records and the plurality of first browsing records in which the target terminal devices are terminal devices visiting the designated location after browsing promotional information corresponding to the designated location, the problem in a related art that a vendor cannot determine whether the promotional information published on a website appeals to customers or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers did the promotional information published on the website help to bring in.

FIG. 7 is a block diagram of an apparatus for monitoring terminal devices according to an exemplary embodiment of the present disclosure. As shown in FIG. 7, the apparatus for monitoring the terminal devices is applied in the monitor 110 in the operating environment illustrated in FIG. 1, the apparatus for monitoring the terminal devices includes, but is not limited to, an identification obtaining module 710, a time recording module 720, a record generating module 730 and a record sending module 740.

The identification obtaining module 710 is configured for obtaining terminal device identifications of terminal devices visiting a designated location.

The time recording module 720 is configured for recording a visiting time of the terminal devices.

The record generating module 730 is configured for generating visiting records of the terminal devices visiting the designated location according to the terminal device identifications of the terminal devices obtained by the identification obtaining module 710 and the visiting time of the terminal devices recorded by the time recording module 720.

The record sending module 740 is configured for sending the visiting records generated by the record generating module 730 to a server, in which the visiting records are configured for instructing the server to obtain a plurality of first browsing records of promotional information corresponding to each terminal device that visits the designated location, and to identify target terminal devices according to the visiting records and the plurality of first browsing records, in which the target terminal devices are terminal devices visiting the designated location after browsing promotional information corresponding to the designated location.

As described above, according to the apparatus for monitoring terminal devices in the embodiments of the present disclosure, by recording the terminal device identifications and the visiting time of the terminal devices visiting the designated location, by generating the visiting records of the terminal devices visiting the designated location according to the terminal device identifications and the visiting time of the terminal devices and by sending the visiting records to the server such that the server may obtain the plurality of first browsing records of promotional information corresponding to each terminal device that visits the designated location and by identifying the target terminal devices according to the visiting records and the plurality of first browsing records, in which the target terminal devices are terminal devices visiting the designated location after browsing promotional information corresponding to the designated location, the problem in a related art that a vendor cannot determine whether the promotional information published on a website appeals to customers or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers did the promotional information published on the website help to bring in.

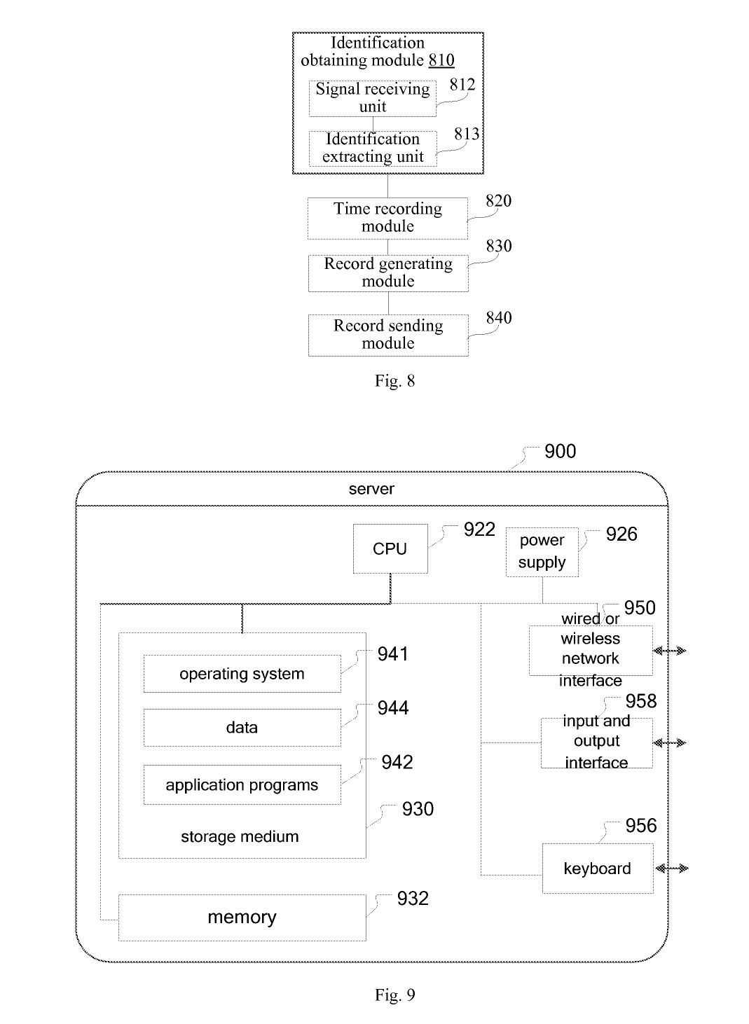

FIG. 8 is a block diagram of an apparatus for monitoring terminal devices according to an exemplary embodiment of the present disclosure. As shown in FIG. 8, the apparatus for monitoring the terminal devices is applied in the monitor 110 in the operating environment illustrated in FIG. 1, the apparatus for monitoring the terminal devices includes, but is not limited to, an identification obtaining module 810, a time recording module 820, a record generating module 830 and a record sending module 840.

The identification obtaining module 810 is configured for obtaining terminal device identifications of terminal devices visiting a designated location.

The time recording module 820 is configured for recording a visiting time of the terminal devices.

The record generating module 830 is configured for generating visiting records of the terminal devices visiting the designated location according to the terminal device identifications of the terminal devices obtained by the identification obtaining module 810 and the visiting time of the terminal devices recorded by the time recording module 820.

The record sending module 840 is configured for sending the visiting records generated by the record generating module 830 to a server, in which the visiting records are configured for instructing the server to obtain a plurality of first browsing records of promotional information corresponding to each terminal device that visits the designated location, and to identify target terminal devices according to the visiting records and the plurality of first browsing records, in which the target terminal devices are terminal devices visiting the designated location after browsing promotional information corresponding to the designated location.

In a possible implementation of this embodiment, the identification obtaining module 810 includes: a signal receiving unit 811, configured for receiving a broadcasting signal sent by a first terminal device, in which the broadcasting signal comprises WiFi signal and/or Bluetooth signal; an identification extracting unit 812, configured for extracting the terminal device identification of the first terminal device from the broadcasting signal received by the signal receiving unit 811, in which the terminal device identification comprises a MAC address of the first terminal device.

As described above, according to the apparatus for monitoring terminal devices in the embodiments of the present disclosure, by recording the terminal device identifications and the visiting time of the terminal devices visiting the designated location, by generating the visiting records of the terminal devices visiting the designated location according to the terminal device identifications and the visiting time of the terminal devices and by sending the visiting records to the server such that the server may obtain the plurality of first browsing records of promotional information corresponding to each terminal device that visits the designated location and by identifying the target terminal devices according to the visiting records and the plurality of first browsing records, in which the target terminal devices are terminal devices visiting the designated location after browsing promotional information corresponding to the designated location, the problem in a related art that a vendor cannot determine whether the promotional information published on a website appeals to customers or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers did the promotional information published on the website help to bring in.

Embodiments of the present disclosure provide a system for identifying target terminal devices, which may include a server and a monitor. The server is connected with the monitor via a wired or wireless network, the server includes an apparatus for identifying the target terminal devices illustrated in FIG. 5, FIG. 6a or FIG. 6c. The monitor is connected with the server via a wired or wireless network, the monitor includes an apparatus for monitoring terminal devices illustrated in FIG. 7 or FIG. 8. Concerning the detailed description of the apparatus for identifying the target terminal devices, reference is made to embodiments corresponding to the apparatus for identifying the target terminal devices; and concerning the detailed description of the apparatus for monitoring the terminal devices, reference is made to embodiments corresponding to the apparatus for monitoring the terminal devices, which are not described herein.

As described above, according to the system for identifying target terminal devices in the embodiments of the present disclosure, by obtaining the visiting records of the terminal devices visiting the designated location, by obtaining the plurality of first browsing records of the promotional information corresponding to each terminal device that visits the designated location, and by identifying the target terminal devices according to the visiting records and the plurality of first browsing records in which the target terminal devices are terminal devices visiting the designated location after browsing promotional information corresponding to the designated location, the problem in a related art that a vendor cannot determine whether the promotional information published on a website appeals to customers or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers did the promotional information published on the website help to bring in.

It should be explained that, the apparatus for identifying target terminal devices and the apparatus for monitoring terminal devices provided in the above embodiments merely take the above modules as an example when the apparatus for identifying target terminal devices identifies the target terminal devices and the apparatus for monitoring terminal devices monitors the terminal devices. In an actual implementation, the above functions may be implemented by different modules as needed. That is, an inner structure of the terminal device may be divided into different modules, so as to implement part or all of the above functions. In addition, the apparatus for identifying the target terminal devices provided in the above embodiments and the embodiments regarding the method for identifying the target terminal devices belong to a same concept, and the apparatus for monitoring the terminal devices and the embodiments regarding the method for monitoring the terminal devices belong to a same concept, concerning the specific implementations of the apparatus for identifying the target terminal devices and the apparatus for monitoring the terminal devices, reference is made to embodiments of the methods, which are not elaborated herein.

FIG. 9 is a schematic diagram of a server according to an exemplary embodiment of the present disclosure. The server 900 may vary widely in configuration or capabilities, but it may include one or more central processing units (CPUs) 922 and a memory 932, one or more storage mediums 930 (such as one or more mass storage devices) for storing application programs 942 or data 944. The memory 932 and the storage mediums 930 may be transitory or non-transitory. The application programs stored in the storage mediums 930 may include one or more modules (not shown), each module may include a series of instructions for the server. Furthermore, the central processing unit 922 may be configured to communicate with the storage medium 930 to execute the series of instructions stored in the storage medium 930 on the server 900 to perform all or part of the steps in the above described methods at the server side.

The server 900 may further include one or more power supplies 926, one or more wired or wireless network interfaces 950, one or more input and output interfaces 958, one or more keyboards 956 and/or one or more operating systems 941, such as Windows Server™, Mac OS X™, Unix™, Linux™, FreeBSD™ and so on.

In exemplary embodiments, there is also provided a non-transitory computer-readable storage medium including instructions, such as the memory 1004 including instructions, and the instructions are executable by the processor 922 of the server 900, for performing the above-described methods. For example, the non-transitory computer-readable storage medium may be a ROM, a RAM (random access memory), a CD-ROM, a magnetic tape, a floppy disc, an optical data storage device, and the like.

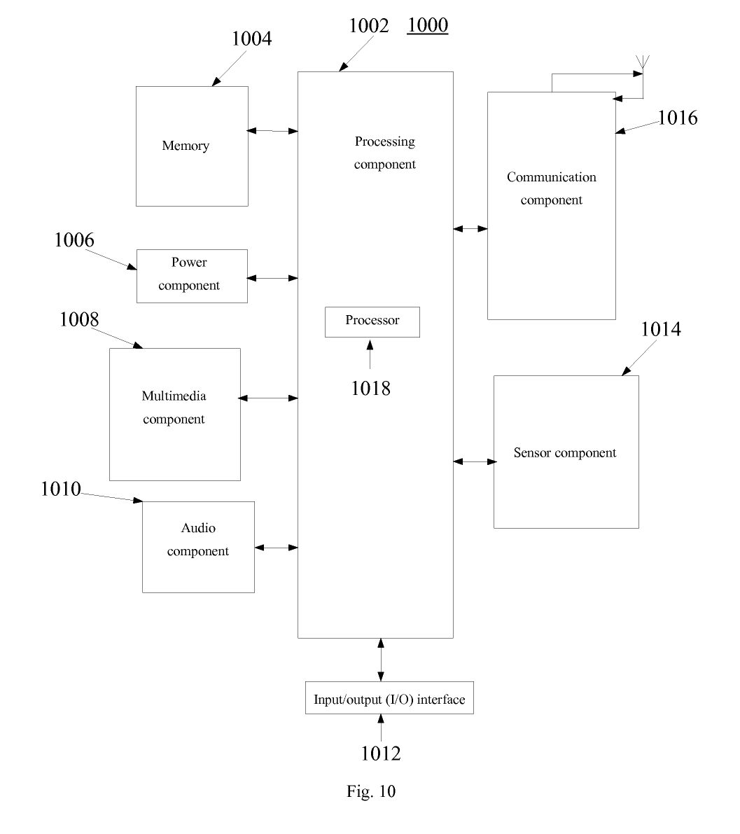

FIG. 10 is a schematic diagram of a monitor 1000 according to an exemplary embodiment of the present disclosure. For example, the monitor 1000 may be a mobile phone, a computer, a router, a networking device, a digital broadcasting terminal, a message receiving and sending equipment, a game controller, a tablet device, a medical equipment, a fitness equipment, a PDA and so on.

Referring to FIG. 10, the monitor 1000 may include one or more of the following components: a processing component 1002, a memory 1004, a power component 1006, a multimedia component 1008, an audio component 1010, an input/output (I/O) interface 1012, a sensor component 1014, and a communication component 1016. However, it is understood that implementing all of the illustrated components is not a requirement. Greater or fewer components may alternatively be implemented.

The processing component 1002 typically controls overall operations of the monitor 1000, such as the operations associated with display, telephone calls, data communications, camera operations, and recording operations. The processing component 1002 may include one or more processors 1018 to execute instructions to perform all or part of the steps in the above described methods at the monitor side. Moreover, the processing component 1002 may include one or more modules which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the monitor 1000. Examples of such data include instructions for any applications or methods operated on the monitor 1000, contact data, phonebook data, messages, pictures, videos, etc. The memory 1004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the monitor 1000. The power component 1006 may include a power management system, one or more power sources, and any other components associated with the generation, management, and distribution of power in the monitor 1000.

The multimedia component 1008 includes a screen providing an output interface between the monitor 1000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 1008 includes a front camera and/or a rear camera. The front camera and the rear camera may receive an external multimedia datum while the monitor 1000 is in an operation mode, such as a photographing mode or a video mode. Each of the front camera and the rear camera may be a fixed optical lens system or have focus and optical zoom capability.

The audio component 1010 is configured to output and/or input an audio signal. For example, the audio component 1010 includes a microphone (“MIC”) configured to receive an external audio signal when the monitor 1000 is in an operation mode, such as a call mode, a recording mode, and a voice recognition mode. The received audio signal may be further stored in the memory 1004 or transmitted via the communication component 1016. In some embodiments, the audio component 1010 includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes one or more sensors to provide status assessments of various aspects of the monitor 1000. For instance, the sensor component 1014 may detect an opened/closed status of the monitor 1000, relative positioning of components (e.g., the display and the keypad) of the monitor 1000, a change in position of the monitor 1000 or a component of the monitor 1000, a presence or absence of user contact with the monitor 1000, an orientation or an acceleration/deceleration of the monitor 1000, and a change in temperature of the monitor 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate wired or wireless communication between the monitor 1000 and other devices. The monitor 1000 can access a wireless network based on a communication standard, such as WiFi, 2G, or 3G, or a combination thereof. In one exemplary embodiment, the communication component 1016 receives a broadcast signal or broadcast associated information from an external broadcast management system via a broadcast channel. In one exemplary embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the monitor 1000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods according to embodiments of the present disclosure.

In exemplary embodiments, there is also provided a non-transitory computer-readable storage medium including instructions, such as the memory 1004 including instructions, and the instructions are executable by the processor 1018 of the monitor 1000, for performing the above-described methods. For example, the non-transitory computer-readable storage medium may be a ROM, a RAM (random access memory), a CD-ROM, a magnetic tape, a floppy disc, an optical data storage device, and the like.

A system for identifying target terminal devices is provided. The system may include the server illustrated in FIG. 9 and the monitor illustrated in FIG. 10. Concerning the detailed descriptions of the server and the monitor, reference is made to the corresponding embodiments, which are not elaborated herein.

As described above, according to the system for identifying target terminal devices in the embodiments of the present disclosure, by obtaining the visiting records of the terminal devices visiting the designated location, by obtaining the plurality of first browsing records of the promotional information corresponding to each terminal device that visits the designated location, and by identifying the target terminal devices according to the visiting records and the plurality of first browsing records in which the target terminal devices are terminal devices visiting the designated location after browsing promotional information corresponding to the designated location, the problem in a related art that a vendor cannot determine whether the promotional information published on a website appeals to customers or cannot determine how many customers did the promotional information appeals to is solved, and an effect of determining which terminal devices of the terminal devices visiting a designated location are terminal devices visiting the designated location after browsing promotional information corresponding to the designated location is achieved, and thus the vendor can determine how many customers did the promotional information published on the website help to bring in.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for identifying target terminal devices, comprising:
obtaining visiting records of terminal devices visiting a designated location;
obtaining a plurality of first browsing records of promotional information corresponding to each terminal device that visits the designated location; and
identifying the target terminal devices according to the visiting records and the plurality of first browsing records, wherein the target terminal devices are terminal devices visiting the designated location after browsing promotional information corresponding to the designated location.

2. The method according to claim 1, wherein identifying the target terminal devices according to the visiting records and the plurality of first browsing records comprises:
detecting whether the promotional information corresponding to the designated location is browsed by a first terminal device according to the plurality of first browsing records;
detecting whether a browsing time of the first terminal device is earlier than a visiting time when the first terminal device visits the designated location, if it is detected that the promotional information corresponding to the designated location is browsed by the first terminal device; and
identifying the first terminal device as one of the target terminal devices, if it is detected that the browsing time is earlier than the visiting time.

3. The method according to claim 2, wherein detecting whether the promotional information corresponding to the designated location is browsed by the first terminal device according to the plurality of first browsing records comprises:
if each first browsing record comprises a terminal device identification, a promotional information identification, a designated location identification and a browsing time corresponding to the promotional information, detecting whether there is a first browsing record comprising a terminal device identification of the first terminal device and a designated location identification of the designated location;
if each first browsing record comprises a terminal device identification, a promotional information identification and a browsing time, obtaining a promotional information library corresponding to the designated location; and detecting whether the promotional information corresponding to the designated location is browsed by the first terminal device according to the first browsing record and the promotional information library.

4. The method according to claim 2, wherein detecting whether the browsing time of the first terminal device is earlier than the visiting time when the first terminal device visits the designated location comprises:
detecting whether the browsing time of the first terminal device is within a predetermined time range according to the visiting records, wherein the predetermined time range is a period of time earlier than the visiting time when the first terminal device visits the designated location.

5. The method according to claim 1, wherein obtaining the visiting records of the terminal devices visiting the designated location comprises:
obtaining the visiting records collected by a monitor provided at the designated location according to broadcasting signals sent by the terminal devices, wherein the broadcasting signal comprises at least one of WiFi signal and Bluetooth signal.

6. The method according to claim 2, wherein obtaining the visiting records of the terminal devices visiting the designated location comprises:
obtaining the visiting records collected by a monitor provided at the designated location according to broadcasting signals sent by the terminal devices, wherein the broadcasting signal comprises at least one of WiFi signal and Bluetooth signal.

7. The method according to claim 1, further comprising:
obtaining a second browsing record of all promotional information in a promotional information library corresponding to the designated location; and
analyzing all of the promotional information in the promotional information library according to the second browsing record, the plurality of first browsing records and the visiting records.

8. The method according to claim 7, wherein analyzing all of the promotional information in the promotional information library according to the second browsing record, the plurality of first browsing records and the visiting records comprises:
calculating a number of the target terminal devices corresponding to promotional information according to the visiting records and the plurality of first browsing records, for every promotional information;
calculating times that the corresponding promotional information is browsed according to the second browsing record of all of the promotional information; and
calculating a conversion rate of the corresponding promotional information according to the number and the times.

9. The method according to claim 2, further comprising:
obtaining a second browsing record of all promotional information in a promotional information library corresponding to the designated location; and
analyzing all of the promotional information in the promotional information library according to the second browsing record, the plurality of first browsing records and the visiting records.

10. A method for monitoring terminal devices, comprising:
obtaining terminal device identifications of the terminal devices visiting a designated location;
recording a visiting time of the terminal devices;
generating visiting records of the terminal devices visiting the designated location according to the terminal device identifications and the visiting time of the terminal devices;
sending the visiting records to a server, wherein the visiting records are configured for instructing the server to obtain a plurality of first browsing records of promotional information corresponding to each terminal device that visits the designated location; and
identifying target terminal devices according to the visiting records and the plurality of first browsing records, wherein the target terminal devices are terminal devices visiting the designated location after browsing promotional information corresponding to the designated location.

11. The method according to claim 10, wherein obtaining the terminal device identifications of the terminal devices visiting the designated location comprises:
receiving a broadcasting signal sent by a first terminal device, wherein the broadcasting signal comprises WiFi signal and/or Bluetooth signal; and
extracting a terminal device identification of the first terminal device from the broadcasting signal, wherein the terminal device identification comprises a MAC address of the first terminal device.

12. A server for identifying target terminal devices, comprising:
a memory; and
one or more processors;
wherein the one or more processors are stored in the memory and are configured to perform:
obtaining visiting records of terminal devices visiting a designated location;
obtaining a plurality of first browsing records of promotional information corresponding to each terminal device that visits the designated location; and
identifying the target terminal devices according to the visiting records and the plurality of first browsing records, wherein the target terminal devices are terminal devices visiting the designated location after browsing promotional information corresponding to the designated location.

13. The server according to claim 12, wherein identifying the target terminal devices according to the visiting records and the plurality of first browsing records comprises:
detecting whether the promotional information corresponding to the designated location is browsed by a first terminal device according to the plurality of first browsing records;
detecting whether a browsing time of the first terminal device is earlier than a visiting time when the first terminal device visits the designated location, if it is detected that the promotional information corresponding to the designated location is browsed by the first terminal device; and
identifying the first terminal device as one of the target terminal devices, if it is detected that the browsing time is earlier than the visiting time.

14. The server according to claim 13, wherein detecting whether the promotional information corresponding to the designated location is browsed by the first terminal device according to the plurality of first browsing records comprises:
detecting whether there is a first browsing record comprising a terminal device identification of the first terminal device and a designated location identification of the designated location, if each first browsing record comprises a terminal device identification, a promotional information identification, a designated location identification and a browsing time corresponding to the promotional information;
obtaining a promotional information library corresponding to the designated location; and
detecting whether the promotional information corresponding to the designated location is browsed by the first terminal device according to the first browsing record and the promotional information library, if each first browsing record comprises a terminal device identification, a promotional information identification and a browsing time.

15. The server according to claim 13, wherein detecting whether the browsing time of the first terminal device is earlier than the visiting time when the first terminal device visits the designated location comprises:
detecting whether the browsing time of the first terminal device is within a predetermined time range according to the visiting records, wherein the predetermined time range is a period of time earlier than the visiting time when the first terminal device visits the designated location.

16. The server according to claim 12, wherein obtaining the visiting records of the terminal devices visiting the designated location comprises:
obtaining the visiting records collected by a monitor provided at the designated location according to broadcasting signals sent by the terminal devices, wherein the broadcasting signal comprises at least one of WiFi signal and Bluetooth signal.

17. The server according to claim 13, wherein obtaining the visiting records of the terminal devices visiting the designated location comprises:
obtaining the visiting records collected by a monitor provided at the designated location according to broadcasting signals sent by the terminal devices, wherein the broadcasting signal comprises at least one of WiFi signal and Bluetooth signal.

18. The server according to claim 12, wherein the one or more processors are further configure to perform:
obtaining a second browsing record of all promotional information in a promotional information library corresponding to the designated location; and
analyzing all of the promotional information in the promotional information library according to the second browsing record, the plurality of first browsing records and the visiting records.

19. The server according to claim 18, wherein analyzing all of the promotional information in the promotional information library according to the second browsing record, the plurality of first browsing records and the visiting records comprises:
calculating a number of the target terminal devices corresponding to promotional information according to the visiting records and the plurality of first browsing records, for every promotional information;
calculating times that the corresponding promotional information is browsed according to the second browsing record of all of the promotional information; and
calculating a conversion rate of the corresponding promotional information according to the number and the times.

20. The server according to claim 13, wherein the one or more processors are further configure to perform:
obtaining a second browsing record of all promotional information in a promotional information library corresponding to the designated location; and
analyzing all of the promotional information in the promotional information library according to the second browsing record, the plurality of first browsing records and the visiting records.
